(19) United States
(12) Patent Application Publication
(10) Pub. No.: US 2026/0024773 A1
(43) Pub. Date: Jan. 22, 2026

(54) ELECTRODE FOR POWER STORAGE DEVICE, AND METHOD FOR PRODUCING COMPOSITE MATERIAL FOR ACTIVE MATERIAL LAYER

(71) Applicant: KABUSHIKI KAISHA TOYOTA JIDOSHOKKI, Kariya-shi, Aichi-ken (JP)

(72) Inventors: Yushi KONDO, Kariya-shi (JP); Masaki MASUDA, Kariya-shi (JP); Takeshi KONDO, Kariya-shi (JP)

(73) Assignee: KABUSHIKI KAISHA TOYOTA JIDOSHOKKI, Kariya-shi, Aichi-ken (JP)

(21) Appl. No.: 19/112,021

(22) PCT Filed: Aug. 30, 2023
(86) PCT No.: PCT/JP2023/031596

§ 371 Date: Mar. 14, 2025

(30) Foreign Application Priority Data
Sep. 22, 2022 (JP) 2022-151609

(51) Int. Cl. H01M 4/62; C08K 3/04; C09D 5/24; C09D 7/61; C09D 101/28; H01M 4/13

(52) U.S. Cl. CPC H01M 4/622; C09D 5/24; C09D 7/61; C09D 101/286; H01M 4/13; H01M 4/625; C08K 3/041; C08K 2201/001; C08K 2201/011

(57) ABSTRACT

An active material layer of an electrode contains an active material, carbon nanotubes, and CMC derived from carboxymethylcellulose ammonium (NH₄-CMC). The content of CMC derived from NH₄-CMC in the active material layer is 0.3-0.6 mass %. The content of carbon nanotubes in the active material layer is 0.005-0.08 mass %. The active material layer includes a main body portion and an edge portion surrounding the main body portion. The maximum thickness of the edge portion is 104% of the thickness of the main body portion. In a plan view of the electrode in the thickness direction of the active material layer, the maximum dimension of the edge portion from the boundary between the main body portion and the edge portion to the tip of the edge portion is 5 mm.

### TECHNICAL FIELD

The present disclosure relates to an electrode for a power storage device and a method for producing a mixture for an active material layer.

### BACKGROUND ART

Patent Literature 1 discloses a bipolar power storage device obtained by separately manufacturing power storage cells and stacking the power storage cells in series. Each power storage cell includes electrodes, namely, a positive electrode and a negative electrode, and a separator arranged between the negative electrode and the positive electrode. The positive electrode includes a positive active material layer arranged on a central portion of one surface of a positive current collector as a current collector. The positive electrode includes a non-coated portion arranged on the surface of the positive current collector other than the central portion. The non-coated portion has the form of a frame surrounding the positive active material layer. The negative electrode includes a negative active material layer arranged on a central portion of one surface of a negative current collector as a current collector. The negative electrode includes a non-coated portion arranged on the surface of the negative current collector other than the central portion. The non-coated portion has the form of a frame surrounding the negative active material layer. The positive active material layer and the negative active material layer are opposed to each other at opposite sides of the separator.

The power storage cell includes a seal portion arranged between the positive electrode and the negative electrode. The seal portion has the form of a frame. The seal portion is arranged between the non-coated portion of the positive current collector and the non-coated portion of the negative current collector. The seal portion is shaped to surround a peripheral portion of the positive active material layer and a peripheral portion of the negative active material layer. The seal portion ensures a gap between the positive current collector and the negative current collector to prevent a short circuit between the current collectors while providing a liquid-tight seal between the positive current collector and the negative current collector.

### CITATION LIST

### Patent Literature

Patent Literature 1: Japanese Laid-Open Patent Publication No. 2017-16825

### SUMMARY OF INVENTION

### Technical Problem

The positive active material layer may include an edge portion that is greater in thickness than other portions of the positive active material layer. In this case, in the power storage device, the amount of the active material in the edge portion of the positive active material layer is greater than a predetermined amount. Also, the negative active material layer may include an edge portion that is greater in thickness than other portions of the negative active material layer. In this case, when the negative active material layer is compressed to manufacture a negative electrode, the edge portion of the negative active material layer may be damaged.

Moreover, the edge portion of the positive active material layer may spread out. In this case, the planar size of the positive active material layer may become greater than a predetermined size. In addition, since the entire surface of the positive active material layer is opposed to the negative active material layer, the planar size of the negative active material layer is also increased. The edge portion of the negative active material layer may also spread out. In this case, the planar size of the negative active material layer may become greater than a predetermined size. Therefore, occurrence of defects caused by the shapes of the edge portions of the positive active material layer and the negative active material layer need to be reduced.

### Solution to Problem

An aspect of the present disclosure is an electrode for a power storage device. The electrode includes an active material layer arranged on a surface of a current collector and a non-coated portion arranged on the surface of the current collector other than where the active material layer is arranged. The non-coated portion surrounds the active material layer. The active material layer includes a body and an edge portion. The edge portion surrounds the body and is located between the body and the non-coated portion. The body has a thickness of 100 μm or greater and 400 μm or less. The active material layer contains an active material capable of storing and releasing a charge carrier, a carbon nanotube, and CMC derived from carboxymethyl cellulose ammonium (NH₄-CMC). In the active material layer, a content amount of the CMC derived from carboxymethyl cellulose ammonium (NH₄-CMC) is 0.3 mass percent or greater and 0.6 mass percent or less. In the active material layer, a content amount of the carbon nanotube is 0.005 mass percent or greater and 0.08 mass percent or less. The edge portion has a thickness having a maximum value that is 104% of a thickness of the body. In a plan view of the electrode in a thickness-wise direction of the active material layer, the edge portion has a dimension from a boundary between the body and the edge portion to a distal end of the edge portion. The dimension has a maximum value of 5 mm.

Another aspect of the present disclosure is a method for producing a mixture for an active material layer used to manufacture an electrode for a power storage device. The electrode includes an active material layer arranged on a surface of a current collector, and a non-coated portion arranged on the surface of the current collector other than where the active material layer is arranged. The non-coated portion surrounds the active material layer. The active material layer includes a body and an edge portion surrounding the body and located between the body and the non-coated portion. The method includes a first step of preparing a primary material by mixing a powder of an active material capable of storing and releasing a charge carrier with a powder of carboxymethyl cellulose ammonium (NH₄-CMC), a second step of preparing a secondary material by mixing the primary material with a water-containing solvent and a carbon nanotube, and a third step of preparing a mixture by mixing and agitating the secondary material with a water-based binder. A maximum value of a viscosity of the secondary material is referred to as an initial viscosity, and the mixture is agitated in the third step until the viscosity of the mixture becomes less than or equal to ⅓ of the initial viscosity.

### BRIEF DESCRIPTION OF DRAWINGS

FIG. 1 is a cross-sectional view of an electrode in an embodiment.

FIG. 2 is a cross-sectional enlarged view showing an edge portion of an active material layer.

FIG. 3 is a plan view of an electrode of the embodiment.

FIG. 4 is a cross-sectional view of a power storage device.

FIG. 5 is a schematic diagram of a coating device.

FIG. 6 is a chart showing thixotropic characteristics

### DESCRIPTION OF EMBODIMENTS

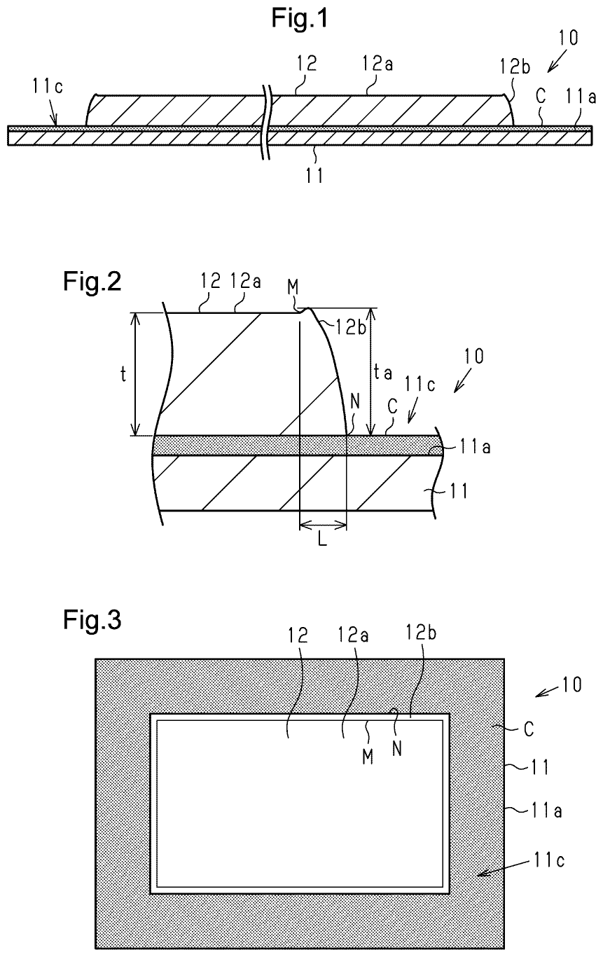

Embodiments of an electrode for a power storage device and a method for producing a mixture for an active material layer will now be described with reference to FIGS. 1 to 6.

### Electrode

An electrode is used as a positive electrode or a negative electrode of a power storage device. The power storage device is, for example, a rechargeable battery such as a nickel-metal hydride battery or a lithium-ion battery. The power storage device may be an electric double-layer capacitor. In the following description, the electrode refers to an electrode of a lithium-ion battery.

As shown in FIGS. 1 and 2, an electrode 10 includes a current collector 11, an active material layer 12 arranged on a first surface 11a of the current collector 11, and a non-coated portion 11c arranged on the first surface 11a of the current collector 11 other than the portion on which the active material layer 12 is arranged. In the description hereafter, viewing of the electrode 10 in the thickness-wise direction of the active material layer 12 is simply referred to as a plan view.

### Current Collector

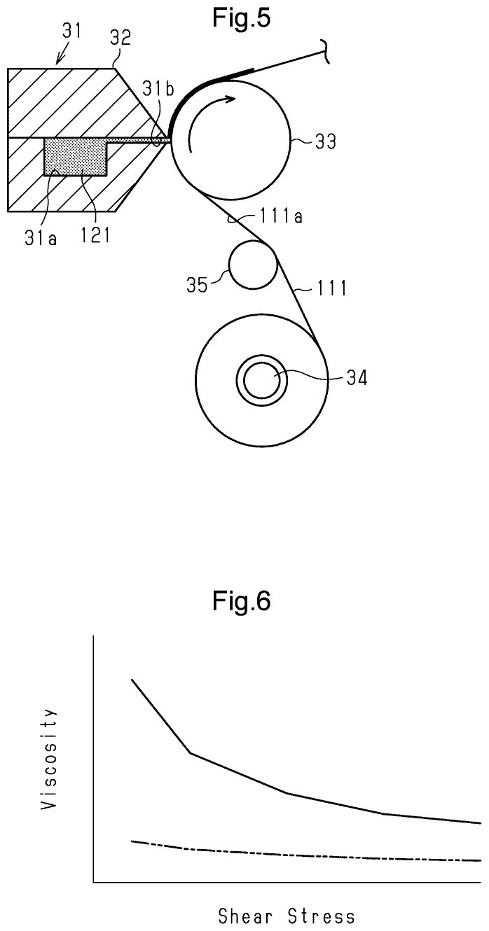

The current collector 11 is a chemically inert electric conductor for allowing current to continuously flow through the active material layer 12 during discharging or charging of the lithium-ion battery. The current collector 11, for example, has the form of a foil. The current collector 11 is rectangular in plan view. The thickness of the current collector 11, having the form of a foil, is, for example, 1 μm or greater and 100 μm or less. It is preferred that the thickness of the current collector 11 is 10 μm or greater and 60 μm or less. The current collector 11 may be formed of, for example, a metal material, a conductive plastic material, or a conductive inorganic material. The current collector 11 is obtained by cutting a belt-shaped current collector material 111, which is shown in FIG. 5, at a fixed interval in the longitudinal direction of the current collector 11.

Examples of the metal material include copper, aluminum, nickel, titanium, and stainless steels. Examples of the conductive plastic material include a plastic obtained by adding a conductive filler to a conductive polymer material or a non-conductive polymer material, as necessary.

When the electrode 10 is used as a positive electrode of the power storage device, it is preferred that the current collector 11 is an aluminum current collector formed of aluminum. The aluminum current collector may be formed of aluminum alone or may be made of an aluminum alloy. Examples of the aluminum alloy include an Al—Mn alloy, an Al—Mg alloy, and an Al—Mg—Si alloy.

The first surface 11a of the current collector 11 is entirely provided with a carbon coat layer C. The thickness of the carbon coat layer C is, for example, 0.1 μm or greater and 5 μm or less. The carbon coat layer C is not particularly limited and may be a known carbon coat layer used for a current collector of an electrode. The carbon coat layer C may be formed by, for example, applying a carbon paste containing carbon particles and a binder to the first surface 11a of the current collector 11 and then solidifying a film formed of the applied carbon paste. The hydrophilicity of the first surface 11a of the current collector 11 is increased with the carbon coat layer C as compared to one without the carbon coat layer C. Hence, the carbon coat layer C including carbon particles and a binder is arranged on the first surface 11a of the current collector 11.

### Active Material Layer

The active material layer 12 may be formed by applying a mixture to the current collector material 111 and then drying and solidifying the mixture. The mixture will be described later.

As shown in FIGS. 2 and 3, the active material layer 12 is formed on the carbon coat layer C arranged on the first surface 11a of the current collector 11. In plan view, the active material layer 12 is rectangular. The current collector 11 will now be described. The current collector 11 includes a non-coated portion 11c surrounding the active material layer 12. The non-coated portion 11c is arranged on the first surface 11a of the current collector 11 other than the portion on which the active material layer 12 is arranged. In plan view, the non-coated portion 11c is rectangular. The non-coated portion 11c includes parts sandwiching two long sides of the active material layer 12 and parts sandwiching two short sides of the active material layer 12.

The active material layer 12 includes a rectangular body 12a and an edge portion 12b. The edge portion 12b surrounds the body 12a and is located between the body 12a and the non-coated portion 11c. The body 12a has a thickness t that is substantially fixed at any position along the first surface 11a. In other words, the thickness t of the body 12a is the thickness of the active material layer 12.

The boundary between the body 12a and the edge portion 12b is denoted by M. The boundary between the first surface 11a and the edge portion 12b is denoted by N. The boundary N is located at the distal end of the edge portion 12b. The edge portion 12b may be shaped to slope downward from the boundary M toward the boundary N or may be shaped to have a thickness that slightly increases from the thickness of the body 12a and then slope downward toward the boundary N. When the thickness of the edge portion 12b is slightly increased from the thickness of the body 12a, the edge portion 12b has a thickness ta having a maximum value that is 104% of the thickness t of the body 12a. Thus, the active material layer 12 is not likely to have an end ridge in which the thickness ta of the edge portion 12b is greater than a predetermined value. The predetermined value is 104% of the maximum value of the thickness t of the body 12a. In plan view, the maximum value of a dimension L from the boundary M to the boundary N is 5 mm. Thus, the active material layer 12 is not likely to have a spread-out such that the dimension L of the edge portion 12b is greater than a predetermined value of 5 mm.

The active material layer 12 contains an active material capable of storing and releasing charge carriers such as lithium ions, a water-based binder, carboxymethyl cellulose derived from carboxymethyl cellulose ammonium, and carbon nanotubes. In the description hereafter, carboxymethyl cellulose ammonium is referred to as “NH₄-CMC.” Carboxymethyl cellulose derived from NH₄-CMC is referred to as “CMC derived from NH₄-CMC.” Carbon nanotubes is referred to as “CNT.”

When the electrode 10 is used as a positive electrode of the power storage device, the active material contained in the active material layer 12 is a positive active material. The positive active material may be a material that can be used as a positive active material of a lithium-ion battery, such as a lithium composite metal oxide having a layered rock-salt structure, a metal oxide having a spinel structure, or a polyanion-based compound. The positive active material may include two or more types of positive active materials. Specific examples of the positive active material include olivine-type lithium iron phosphate (LiFePO₄), which is a polyanionic compound.

When the electrode 10 is used as a negative electrode of the power storage device, the active material contained in the active material layer 12 is a negative active material. The negative active material may be a material that can be used as a negative active material of a lithium-ion battery, such as Li, carbon, a metal compound, or an element or a compound thereof that can be alloyed with lithium. Examples of the carbon include natural graphite, artificial graphite, hard carbon (non-graphitizable carbon), and soft carbon (graphitizable carbon). Examples of the artificial graphite include highly oriented graphite and mesocarbon microbeads. Examples of elements that can be alloyed with lithium include silicon and tin.

The content amount of the active material in the active material layer 12 is not particularly limited. The content amount of the active material in the active material layer 12 is, for example, greater than or equal to 94 mass percent, and preferably greater than or equal to 95 mass percent. The content amount of the active material in the active material layer 12 is, for example, less than or equal to 99.5 mass percent, and preferably less than or equal to 98.5 mass percent.

The water-based binder is configured to be dissolved or dispersed in a water-based solvent. The water-based binder is configured to be mixed with an active material when the water-based solvent is dispersed or dissolved in a water-based solvent. The water-based binder is not particularly limited. A known material as a water-based binder contained in an active material layer of a lithium-ion battery may be used. Examples of the water-based binder include fluorine-containing resins such as polyvinylidene fluoride, polytetrafluoroethylene, and fluororubber; thermoplastic resins such as polypropylene and polyethylene: imide resins such as polyimide and polyamide-imide; acrylic resins such as alkoxysilyl group-containing resins and poly (meth) acrylic acid: styrene-butadiene rubber: alginates such as sodium alginate and ammonium alginate; water-soluble cellulose ester crosslinked products: and starch-acrylic acid graft polymers. The active material layer 12 may contain one type of water-based binder or two or more types of water-based binders.

The content amount of the water-based binder in the active material layer 12 is not particularly limited. The content amount of the water-based binder in the active material layer 12 is, for example, greater than or equal to 0.5 mass percent and is preferably greater than or equal to 1 mass percent. Preferably, the active material layer 12 contains styrene-butadiene rubber as the water-based binder.

The CMC derived from NH₄-CMC is produced when a mixture containing NH₄-CMC is dried and ammonia (NH₃) is entirely or partially separated from the NH₄-CMC. When ammonia (NH₃) is entirely separated from the NH₄-CMC, the produced CMC derived from NH₄-CMC is H-CMC. When ammonia (NH₃) is partially separated from the NH₄-CMC, the produced CMC derived from NH₄-CMC includes both NH₄-CMC and H-CMC.

It is preferred that the Etherification degree of CMC derived from NH₄-CMC is 0.5 or greater and 0.65 or less. In the active material layer 12, the content amount of CMC derived from NH₄-CMC is 0.3 mass percent or greater and 0.6 mass percent or less, and preferably is 0.35 mass percent or greater and 0.5 mass percent or less. In the active material layer 12, the content amount of CMC derived from NH₄-CMC refers to the total content amount of NH₄-CMC and H-CMC. When the mixture is dried and ammonia (NH₃) is entirely separated from NH₄-CMC, the total content amount of NH₄-CMC and H-CMC refers to the total amount of H-CMC.

When the content amount of CMC derived from NH₄-CMC is less than 0.3 mass percent, the mixture forming the active material layer 12 may be poorly dispersed, which is not preferred. When the content amount of CMC derived from NH₄-CMC is greater than 0.6 mass percent, the active material layer 12 becomes less flexible, and the electrode 10 is prone to crack, which is not preferred. Therefore, when the content amount of CMC derived from NH₄-CMC is in the range described above, the active material layer 12 is not likely to have an end ridge in the edge portion 12b while limiting damage on the active material layer 12 during compression. In addition, when the content amount of CMC derived from NH₄-CMC is in the range described above, the adhesion strength of the active material layer 12 to the current collector 11 is increased.

The CNT may be a multi-walled carbon nanotube (MWCNT) or single-walled carbon nanotube (SWCNT). The CNTs may each be solely used. Alternatively, two or more types of CNTs may be used together. The fiber length and the fiber diameter of the CNT are not particularly limited. The fiber length of CNT is, for example, 1 μm or greater and 50 μm or less and is preferably 3 μm or greater and 30 μm or less. The fiber diameter of CNT is, for example, 1 nm or greater and 5 μm or less, preferably, 1.1 nm or greater and 3 μm or less, and, more preferably, 1.2 nm or greater and 2 μm or less. In the present embodiment, SWCNT is used.

The content amount of CNT in the active material layer 12 is 0.005 mass percent or greater and 0.08 mass percent or less, preferably, 0.008 mass percent or greater and 0.06 mass percent or less, and, more preferably, 0.01 mass percent or greater and 0.05 mass percent or less. When the content amount of CNT is in the range described above, the thixotropic characteristic of the mixture forming the active material layer 12 may be maintained. The term “thixotropy” refers to a property of a material initially appears solid-like. When receiving continuous shear stress, such as stirring or shaking, the material decreases in viscosity and becomes liquid. When released from the stress, the viscosity gradually recovers, and the material returns to the original state. Such a property is referred to as the thixotropic characteristic.

The active material layer 12 may include, as necessary, other components in addition to the four components, that is, the active material, the water-based binder, the CNT, and the CMC derived from NH₄-CMC described above. In an example, other components include conductive additives, electrolytes (such as polymer matrix, ion-conductive polymer, and electrolytic solution), and electrolyte supporting salt (lithium salt) to enhance ionic conductivity. Examples of the conductive aid include acetylene black, carbon black, and graphite. The type and the content amount of the other components are not particularly limited. Conventional knowledge about a lithium-ion battery may be referred to.

The active material layer 12 has a relatively large thickness to increase the energy density of the power storage device. When the power storage device is used as a vehicle on-board power supply, in particular, when the power storage device is used as a power source of an electric vehicle, the power storage device needs to have a high energy capacity, such as 50 kWh. Hence, the thickness of the active material layer 12 is increased. The thickness t of the body 12a of the active material layer 12 is 100 μm or greater and 400 μm or less.

The density of the active material layer 12 is not particularly limited. The density of the active material layer 12 is, for example, greater than or equal to 1.0 g/cm³. When the density of the active material layer 12 is high, a long-time output of the power storage device is likely to be decreased due to the content of CNT. The density of the active material layer 12 is, for example, less than or equal to 3.0 g/cm³.

The areal density of the active material layer 12 is not particularly limited, and conventional knowledge about a lithium-ion battery may be referred to. It is preferred that the areal density of the active material layer 12 is increased to increase the energy density of a power storage cell 20. The areal density of a positive active material layer 21b is, for example, 55 mg/cm² or greater and 90 mg/cm² or less. The areal density of a positive active material layer 21b is, preferably, 60 mg/cm² or greater, and, more preferably, 70 mg/cm² or greater. The areal density of a negative active material layer 22b is, for example, 25 mg/cm²or greater and 45 mg/cm² or less. The areal density of a negative active material layer 22b is, preferably, 30 mg/cm² or greater.

### Power Storage Device

An example of a power storage device that uses the electrode 10 will now be described.

The power storage device that uses the electrode 10 is, for example, a power storage module used as a power supply of various vehicles such as a forklift, a hybrid electric vehicle, and an electric vehicle. In the present embodiment, the power storage device is a lithium-ion battery

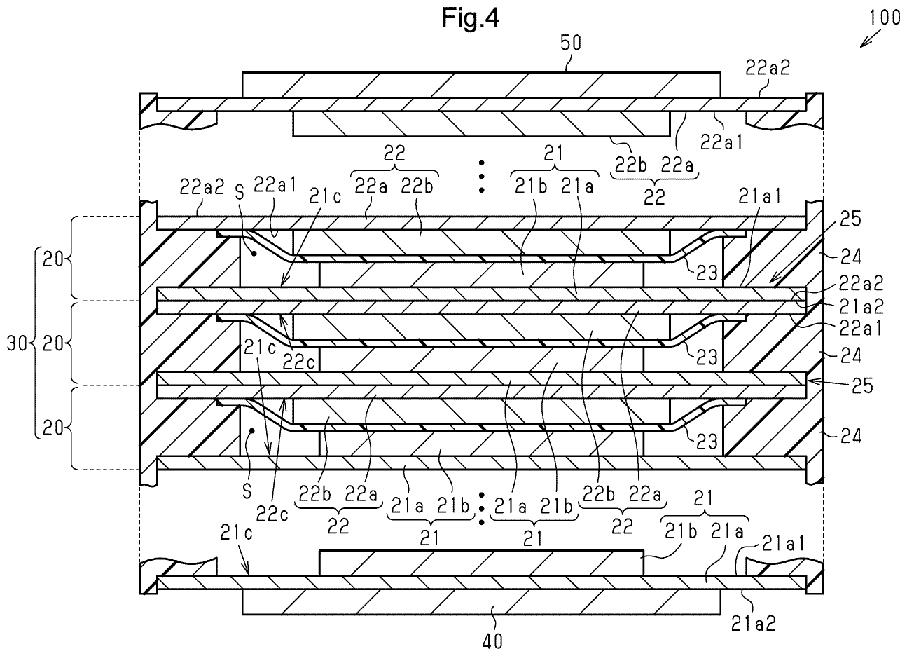

As shown in FIG. 4, a power storage device 100 includes a cell stack 30 in which power storage cells 20 are stacked in a stacking direction. Hereinafter, the stacking direction of the power storage cells 20 will be simply referred to as the stacking direction. The power storage cell 20 includes a positive electrode 21, a negative electrode 22, a separator 23, and a spacer 24. One or both of the positive electrode 21 and the negative electrode 22 of the power storage cell 20 corresponds to the electrode 10. In FIG. 4, the carbon coat layer C is not shown, and the edge portion 12b is not shown in detail.

The positive electrode 21 includes a positive current collector 21 a and a positive active material layer 21b, which is provided on a first surface 21a1 of the positive current collector 21a. When the positive electrode 21 is the electrode 10, the positive current collector 21a is the current collector 11. The positive active material layer 21b is the active material layer 12.

In plan view, the positive active material layer 21b is formed in a central portion of the first surface 21a1 of the positive current collector 21a. A peripheral portion of the first surface 21a1 of the positive current collector 21a in plan view is a positive non-coated portion 21c, on which the positive active material layer 21b is not arranged. The positive non-coated portion 21c is arranged to surround the positive active material layer 21b in plan view.

The negative electrode 22 includes a negative current collector 22a and a negative active material layer 22b arranged on a first surface 22a1 of the negative current collector 22a. When the negative electrode 22 is the electrode 10, the negative current collector 22a is the current collector 11. The negative active material layer 22b is the active material layer 12.

In plan view, the negative active material layer 22b is formed in a central portion of the first surface 22a1 of the negative current collector 22a. A peripheral portion of the first surface 22a1 of the negative current collector 22a in plan view is a negative non-coated portion 22c, on which the negative active material layer 22b is not arranged. The negative non-coated portion 22c is arranged to surround the negative active material layer 22b in plan view. The positive electrode 21 and the negative electrode 22 are disposed so that the positive active material layer 21b and the negative active material layer 22b are opposed to each other in the stacking direction. That is, the direction in which the positive electrode 21 and the negative electrode 22 are opposed to each other conforms to the stacking direction. The negative active material layer 22b is slightly larger than the positive active material layer 21b. When the negative active material layer 22b is slightly larger than the positive active material layer 21b, the entire formation region of the positive active material layer 21b is located within the formation region of the negative active material layer 22b in plan view.

The positive current collector 21a includes a second surface 21a2, which is a surface on the side opposite to the first surface 21a1. The positive electrode 21 is a monopolar electrode, in which neither the positive active material layer 21b nor the negative active material layer 22b is formed on the second surface 21a2 of the positive current collector 21a. The negative current collector 22a includes a second surface 22a2, which is a surface on the side opposite to the first surface 22a1. The negative electrode 22 is a monopolar electrode, in which neither the positive active material layer 21b nor the negative active material layer 22b is formed on the second surface 22a2 of the negative current collector 22a.

The separator 23 is arranged between the positive electrode 21 and the negative electrode 22 and separates the positive electrode 21 and the negative electrode 22 from each other to prevent a short circuit caused by contact of the two electrodes while allowing for passage of charge carriers such as lithium ions.

The separator 23 is, for example, a porous sheet or nonwoven fabric containing a polymer that absorbs and retains electrolyte. Examples of materials used for the separator 23 include polyolefins such as polypropylene and polyethylene, as well as polyester. The separator 23 may have a single-layer structure or a multilayer structure. The multilayer structure may include, for example, an adhesive layer, a ceramic layer as a heat-resistant layer, or the like.

The spacer 24 is disposed between the first surface 21a1 of the positive current collector 21a of the positive electrode 21 and the first surface 22a1 of the negative current collector 22a of the negative electrode 22 and outward from the positive active material layer 21b and the negative active material layer 22b. The spacer 24 is adhered to the positive current collector 21a and the negative current collector 22a. The spacer 24 ensures a gap between the positive current collector 21a and the negative current collector 22a to prevent a short circuit between the positive current collector 21a and the negative current collector 22a, and provides a liquid-tight seal between the positive current collector 21a and the negative current collector 22a.

In plan view, the spacer 24 has the form of a frame that extends along the peripheral portions of the positive current collector 21a and the negative current collector 22a and surrounds the positive current collector 21a and the negative current collector 22a. The spacer 24 is disposed between the positive non-coated portion 21c of the first surface 21a1 of the positive current collector 21a and the negative non-coated portion 22c of the first surface 22a1 of the negative current collector 22a.

Examples of materials used for the spacer 24 include various plastic materials such as polyethylene (PE), modified polyethylene (modified PE), polystyrene (PS), polypropylene (PP), modified polypropylene (modified PP), ABS plastic, and AS plastic.

A sealed space S is formed inside the power storage cell 20 and surrounded by the frame-shaped spacer 24, the positive electrode 21, and the negative electrode 22. The sealed space S accommodates the separator 23 and electrolyte. A peripheral portion of the separator 23 is embedded in the spacer 24.

The electrolyte includes, for example, liquid electrolyte and polymer gel electrolyte containing electrolyte retained in a polymer matrix. Examples of the liquid electrolyte include a liquid electrolyte containing a nonaqueous solvent and an electrolyte salt dissolved in the nonaqueous solvent. As the electrolyte salts, known lithium salts such as LiClO₄, LiAsF₆, LiPF₆, LiBF₄, LiCF₃SO₃, LiN(FSO₂)₂, and LiN(CF₃SO₂)₂ may be used. As the nonaqueous solvent, known solvents such as cyclic carbonates, cyclic esters, chain carbonates, chain esters, and ethers may be used. These known solvent materials may be used in a combination of two or more thereof.

The spacer 24 seals the sealed space S between the positive electrode 21 and the negative electrode 22, thereby preventing leakage of the electrolyte accommodated in the sealed space S to the outside. The spacer 24 may also prevent water from entering the sealed space S from the outside of the power storage device 100. In addition, the spacer 24 may prevent gas generated in the positive electrode 21 or the negative electrode 22, for example, due to charge-discharge reactions, from leaking out of the power storage device 100. In order for the spacer 24 having the functions described above to be arranged between the positive electrode 21 and the negative electrode 22, the positive electrode 21 includes the positive non-coated portion 21c, and the negative electrode 22 includes the negative non-coated portion 22c.

The cell stack 30 has a structure in which the power storage cells 20 are stacked so that the second surfaces 21a2 of the positive current collectors 21a are in contact with the second surfaces 22a2 of the negative current collectors 22a. Thus, the power storage cells 20, which form the cell stack 30, are connected in series.

In the cell stack 30, any two of the power storage cells 20 adjacent to each other in the stacking direction form a quasi-bipolar electrode 25, in which the positive current collector 21a and the negative current collector 22a that are in contact with each other are regarded as a single current collector. Each of the quasi-bipolar electrodes 25 includes a current collector, which has a structure in which a positive current collector 21a and a negative current collector 22a are stacked, a positive active material layer 21b, which is formed on one surface of the current collector, and a negative active material layer 22b, which is formed on the other surface of the current collector.

The positive current collector 21a and the negative current collector 22a may form a bipolar current collector in which the second surface 21a2 of the positive current collector 21a is bonded to the second surface 22a2 of the negative current collector 22a. In this case, the positive electrode 21 and the negative electrode 22 form a bipolar electrode 25 in which the positive current collector 21a and the negative current collector 22a are bonded to each other and served as a single bipolar current collector.

The power storage device 100 includes two conductive bodies formed of a positive energization plate 40 and a negative energization plate 50 arranged to sandwich the cell stack 30 in the stacking direction of the cell stack 30. The positive energization plate 40 and the negative energization plate 50 are each formed of a material having good conductivity.

The positive energization plate 40 is electrically connected to the second surface 21a2 of the positive current collector 21a of the positive electrode 21 disposed at the outermost position at one end in the stacking direction. The negative energization plate 50 is electrically connected to the second surface 22a2 of the negative current collector 22a of the negative electrode 22 disposed at the outermost position at the other end in the stacking direction.

The power storage device 100 is charged or discharged through terminals arranged on the positive energization plate 40 and the negative energization plate 50. As the material forming the positive energization plate 40, for example, the material forming the positive current collector 21a may be used. The positive energization plate 40 may be formed of a metal plate thicker than the positive current collector 21a used in the cell stack 30. As the material forming the negative energization plate 50, for example, the material forming the negative current collector 22a may be used. The negative energization plate 50 may be formed of a metal plate thicker than the negative current collector 22a used in the cell stack 30.

### Method for Manufacturing Electrode for Power Storage Device

A method for manufacturing the electrode 10 will now be described.

The electrode 10 is manufactured by sequentially performing a mixture manufacturing step and an active material layer forming step.

### Composite Material Producing Step

The method for producing the mixture includes a first step of preparing a primary material by mixing a powder of an active material and a powder of NH₄-CMC, a second step of preparing a secondary material by mixing the primary material with a water-containing solvent and CNT, and a third step of preparing a slurry of a mixture by mixing and agitating a styrene-butadiene rubber with the secondary material. In the description hereafter, styrene-butadiene rubber will be referred to as [SBR].

When the total mass of solid content included in the mixture is considered as 100 parts by mass, it is preferred that the content amount of the active material be 94 parts by mass or greater and 95 parts by mass or less. It is preferred that the proportion of NH₄-CMC that is mixed in the first step be 0.3 parts by mass or greater and 0.6 parts by mass or less. The mixing process in the first step is not particularly limited as long as the solid content included in the primary material is uniformly dispersed. A conventional power mixing process may be used. The mixing process described above includes, for example, manual stirring using a stirrer or the like or mechanical stirring using an ultrasonic disperser or the like.

In the second step, a water-containing solvent and CNT are mixed with the primary material to prepare the secondary material. The CNT is prepared in advance in a paste form. The secondary material is prepared by mixing the water-containing solvent and CNT with the primary material and agitating the mixture. When the secondary material is in the form a slurry mixed with a solvent or in a capillary state, the maximum value of the viscosity of the second material is considered as an initial viscosity. The initial viscosity may be specified after the third step is performed. It is preferred that the water-containing solvent be a solvent containing water as a main component. In an example, the ratio of water in the solvent is 50 to 100 mass percent. In the present embodiment, water is used as the solvent. In an example, water is mixed with the mixture so that the solid content rate in the mixture is 50 mass percent or greater and 70 mass percent or less.

In the third step, SBR is added to the secondary material and agitated to prepare a slurry of the mixture. The SBR is prepared in advance in a paste form. When the total mass of solid content included in the mixture is considered as 100 parts by mass, it is preferred that the content amount of CNT be 0.005 parts by mass or greater and 0.08 parts by mass or less. When the total mass of solid content included in the mixture is considered as 100 parts by mass, it is preferred that the content amount of SBR be 1.0 parts by mass or greater and 5.0 parts by mass or less.

A specific agitating process in the second step and the third step is not particularly limited as long as the components included in the secondary material and the mixture are uniformly agitated. A conventional agitating process used for producing a mixture for an electrode of a rechargeable battery may be used. The agitating process described above includes, for example, manual stirring using a stirrer or the like or mechanical stirring using an ultrasonic disperser or a conventional mixer such as a planetary mixer, a homomixer, a homodisperser, a Henschel mixer, a Banbury mixer, a ribbon mixer, a V-type mixer, or a planetary centrifugal mixer.

In the third step, it is preferred that the mixture be agitated until the viscosity of the mixture becomes less than or equal to ⅓ of the initial viscosity, and more preferably, the viscosity of the mixture becomes less than or equal to ¼ of the initial viscosity. As described above, when the viscosity of the mixture becomes less than or equal to ⅓ of the initial viscosity, a decrease in the viscosity of the mixture caused by the agitation becomes stable and thus is suitable for the coating.

### Active Material Layer Forming Step

In the active material layer forming step, the mixture is applied to a first surface 111a of the current collector material 111 to form a coat layer, and then the coat layer of the mixture is dried. As described above, the current collector material 111 is belt-shaped. The process for applying the mixture to the current collector material 111 includes die coating.

As shown in FIG. 5, a mixture 121 is applied to the current collector material 111 using a coating device 31. The coating device 31 includes a slit die 32, a backup roller 33, a supply roll 34, and a tension roller 35.

The slit die 32 includes a reservoir 31a storing the mixture 121 and a discharge port 31b discharging the mixture 121 from the reservoir 31a. In the slit die 32, a pump, which is not shown, is used to deliver the mixture 121 stored in the reservoir 31a. When delivered by the pump, the mixture 121 is discharged from the discharge port 31b.

The backup roller 33 is arranged to be opposed to the discharge port 31b of the slit die 32. The backup roller 33 is movable relative to the slit die 32 between an application position at which the mixture 121 is applicable from the slit die 32 to the first surface 111a of the current collector material 111 and a retracted position at which the mixture 121 is not applicable from the slit die 32 to the current collector material 111.

The current collector material 111 is rolled on the supply roll 34. The current collector material 111 is fed from the supply roll 34 and supplied to the slit die 32. The tension roller 35 applies tension to the current collector material 111 fed from the supply roll 34. As the current collector material 111 is fed along the backup roller 33, which is moved to the application position, the mixture 121 discharged from the slit die 32 is applied to the first surface 111a of the current collector material 111. As a result, the coat layer of the mixture 121 is formed on the current collector material 111.

The mixture 121 is discharged from the slit die 32 to a location separated from opposite width-wise edges of the current collector material 111. As a result, the non-coated portion 11c, which is free of the mixture 121, is formed at the opposite width-wise sides of the current collector material 111.

The discharging of the mixture 121 from the slit die 32 and the stopping of the discharging are each performed at a determined time so that the mixture 121 is intermittently applied to the first surface 111a of the current collector material 111. The intermittent application of the mixture 121 forms a start end and a termination end of the mixture 121 on the coat layer. The start end of the mixture 121 is formed on a first end of the active material layer 12, which is formed by drying the coat layer, in a longitudinal direction of the active material layer 12. The terminal end of the mixture 121 is formed on a second end of the active material layer 12, which is formed by drying the coat layer, in a longitudinal direction of the active material layer 12. The thickness, the length in the longitudinal direction, and the width of the mixture 121 are set in accordance with the size of the lithium-ion battery.

When the discharging of the mixture 121 from the slit die 32 is stopped, the non-coated portion 11c, which is free of the mixture 121, is formed between any two of the coat layers adjacent to each other in the longitudinal direction of the current collector material 111. When stopping the discharging, pressure applied to the slit die 32 is instantaneously decreased by a suck-back mechanism, which is not shown, so that the discharging of the mixture 121 is instantaneously stopped. As a result, the coat layer of the mixture 121 and the non-coated portion 11c are alternately formed in the longitudinal direction of the current collector material 111.

The process for drying the coat layer of the mixture 121 uses, for example, natural drying, cold air, hot air, vacuum, infrared, far-infrared, electron wire, and microwave. Two or more types of the drying processes may be combined. The dry temperature is 20 degrees or greater and 120 degrees or less and, more preferably, 40 degrees or greater and 100 degrees or less.

When the coat layer of the mixture 121 is dried, NH₃ is separated from NH₄-CMC contained in the mixture 121. As a result, CMC derived from NH₄-CMC is mixed in the active material layer 12.

In addition, subsequent to the drying step, a compressing step of compressing the active material layer 12 may be performed to increase the electrode density. The process for compressing the active material layer 12 includes, for example, roll pressing, die pressing, and calendar pressing. The pressure applied by the pressing is, preferably, 0.1 t/cm² or greater and 10 t/cm² or less, and, more preferably, 0.5 t/cm² or greater and 5.0 t/cm² or less.

A rolling step of rolling the electrode 10 may be performed at least partially during each of the coating step, the drying step, and the compressing step or after the compressing step. After the compressing step, the drying step may be again performed. As a result, the active material layer 12 is formed on the current collector material 111.

The current collector material 111 on which the active material layer 12 is formed is cut at the non-coated portion 11c located between the active material layers 12. This manufactures the electrode 10.

### Method for Manufacturing Power Storage Device

The process for manufacturing the power storage device 100 will now be described.

The power storage device 100 is manufactured by sequentially performing a power storage cell forming step and a cell stack forming step.

### Power Storage Cell Forming Step

In the power storage cell forming step, the positive electrode 21 and the negative electrode 22 are arranged so that the positive active material layer 21b and the negative active material layer 22b are located at opposite sides of the separator 23 and opposed to each other in the stacking direction, and the spacer 24 is arranged between the positive electrode 21 and the negative electrode 22 and on the positive non-coated portion 21c and the negative non-coated portion 22c. In this state, the edge portion 12b of the positive active material layer 21b is opposed to the negative active material layer 22b via the separator 23. The edge portion 12b of the negative active material layer 22b is opposed to the separator 23.

Subsequently, the positive electrode 21, the negative electrode 22, the separator 23, and the spacer 24 are welded and integrated with each other to form an assembly. The process of welding the spacer 24 includes, for example, a known welding process such as thermal welding, ultrasonic welding, or infrared welding.

The electrolyte is added to the sealed space S through an inlet of the spacer 24, and then the inlet is sealed. This forms the power storage cell 20.

### Cell Stack Forming Step

In the cell stack forming step, the power storage cells 20 are stacked so that the second surfaces 21a2 of the positive current collectors 21a are opposed to the second surfaces 22a2 of the negative current collectors 22a. In this step, the second surface 21a2 of the positive current collector 21a of one power storage cell 20 is in contact with the second surface 22a2 of the negative current collector 22a of another power storage cell 20. Then, peripheral portions of the spacers 24 in adjacent ones of the power storage cells 20 in the stacking direction are bonded to each other to integrate the power storage cells 20.

The positive energization plate 40 is stacked on the second surface 21a2 of the positive current collector 21a of the positive electrode 21 that is located at an outermost end in the stacking direction. The energization plate 40 is electrically connected and fixed to the positive electrode 21. In the same manner, the negative energization plate 50 is stacked on the second surface 22a2 of the negative current collector 22a of the negative electrode 22 that is located at the other outermost end in the stacking direction. The negative energization plate 50 is electrically connected and fixed to the negative electrode 22. In this state, the second surface 22a2 of the negative current collector 22a is in contact with the negative energization plate 50. The steps described above form the power storage device 100.

### Operation of Embodiment

Operation of the present embodiment will now be described.

The active material layer 12 contains 0.3 mass percent or greater and 0.6 mass percent or less of CMC derived from NH₄-CMC. The mixture 121 forming the active material layer 12 contains NH₄-CMC.

In FIG. 6, the solid line shows the relationship of the viscosity and shear stress of a mixture 121 that contains 0.4 mass percent of NH₄-CMC and 0.05 mass percent of SWCNT after being agitated for thirty minutes. In FIG. 6, the double-dashed line shows the relationship of the viscosity and shear stress of a mixture 121 that does not containing SWCNT after being agitated for thirty minutes. As shown in FIG. 6, as compared to when SWCNT is not contained, the viscosity is maintained high at a low shear stress. Thus, the thixotropic characteristic of the mixture 121 is improved. When the thixotropic characteristic of the mixture 121 is improved, the viscosity of the mixture 121 is increased as compared to when NH₄-CMC is not contained.

Thus, when the mixture 121 is applied to the current collector material 111 to form a coat layer, the start end and the terminal end of the coat layer is less likely to have an end ridge. As a result, when the coat layer is dried to form the active material layer 12, the edge portion 12b formed of the start end and the terminal end is less likely to have an end ridge.

When the mixture 121 contains 0.05 mass percent of SWCNT, the viscosity of the mixture 121 is increased at a low shear stress. When the mixture 121 contains NH₄-CMC, as indicated by the double-dashed line in FIG. 6, the inventors found that the thixotropic characteristic has disappeared as a result of the agitation of the mixture 121.

The inventors also found that when the mixture 121 contains CNT, the thixotropic characteristic is likely to be maintained, and the mixture 121 is less likely to be decreased in viscosity and become a liquid state.

In the present embodiment, the active material layer 12 includes, as CNT, SWCNT of 0.005 mass percent or greater and 0.08 mass percent or less. That it, the mixture 121, which forms the active material layer 12, also contains SWCNT. Thus, when the mixture 121 is applied to the current collector material 111 to form a coat layer, an edge portion of the coat layer is less likely to spread out. As a result, when the coat layer is dried to form the active material layer 12, the edge portion 12b is less likely to spread out.

### Advantages of Embodiment

The above embodiment has the following advantages.
(1) In the electrode 10 of the power storage device, the content amount of CMC derived from NH₄-CMC in the active material layer 12 is 0.3 mass percent or greater and 0.6 mass percent or less. Thus, the edge portion 12b of the active material layer 12 is less likely to have an end ridge.

In the positive active material layer 21b of the positive electrode 21, the edge portion 12b is less likely to have an end ridge. Therefore, in the power storage device 100, the amount of the active material in the edge portion 12b of the positive active material layer 21b is less likely to exceed a predetermined amount. This avoids a situation in which, during compression of the positive active material layer 21b, the edge portion 12b of the positive active material layer 21b is excessively compressed corresponding to an end ridge. Also, in the negative active material layer 22b of the negative electrode 22, the edge portion 12b is less likely to have an end ridge. Thus, when the negative active material layers 22b are arranged on opposite surfaces of the negative current collector 22a, the edge portion 12b of the negative active material layer 22b is less likely to be excessively compressed corresponding to an end ridge during compression of the negative active material layer 22b. When the negative active material layer 22b is arranged on a surface of the negative current collector 22a and the positive active material layer 21b is arranged on the other surface of the negative current collector 22a, a situation in which the edge portion 12b of the negative active material layer 22b is bent and damaged is avoided during compression of the negative active material layer 22b. In addition, in the power storage device 100, the edge portion 12b of the negative active material layer 22b is less likely to extend through the separator 23.

The active material layer 12 contains 0.005 mass percent or greater and 0.08 mass percent or less of CNT. Thus, when the mixture 121 is applied to the current collector material 111 to form a coat layer, an edge portion of the coat layer is less likely to spread out. As a result, when the coat layer is dried to form the active material layer 12, the edge portion 12b is less likely to spread out.

This limits an increase in the planar size of the positive active material layer 21b so as to be greater than a predetermined size. Since the entire surface of the positive active material layer 21b is opposed to the negative active material layer 22b, the planar size of the negative active material layer 22b is less likely to be increased. In addition, the edge portion 12b of the negative active material layer 22b is less likely to spread out. This limits an increase in the planar size of the negative active material layer 22b to be greater than a predetermined size. Therefore, occurrence of defects caused by the shape of the edge portion 12b of the active material layer 12 is limited.
(2) The carbon coat layer C is arranged on the first surface 11a of the current collector 11. The active material layer 12 is formed on the carbon coat layer C. The carbon coat layer C improves the adhesion strength of the active material layer 12 to the current collector 11.
(3) The CNT is a single-walled carbon nanotube. Since the single-walled carbon nanotube has a greater fiber length than the multi-walled carbon nanotube, the thixotropic characteristic of the mixture 121 is improved. This allows for a reduction in the amount of CNT to provide the mixture 121 with a desired thixotropic characteristic. As a result, the amount of CNT to limit a spread-out of the edge portion 12b of the active material layer 12 is decreased.

The above embodiments may be modified as follows. The present embodiment and the following modifications can be combined as long as they remain technically consistent with each other.

The formation range of the carbon coat layer C on the first surface 11a of the current collector 11 may be changed. In an example, the carbon coat layer C may be formed in only the range of the first surface 11a where the active material layer 12 is formed. In an example, the carbon coat layer C may be formed on a portion of the range.

The electrode 10 may have a bipolar structure. The electrode 10 includes a bipolar current collector. The bipolar current collector is a stacked body formed by integrally bonding a positive current collector foil and a negative current collector foil in the thickness direction. The bipolar current collector includes, for example, a current collector in which aluminum foils are bonded to each other and a current collector in which an aluminum foil and a copper foil are bonded to each other.

The specific structure of the power storage device 100 that uses the electrode 10 is not particularly limited as long as at least one positive electrode or at least one negative electrode correspond to the electrode 10. For example, the number of the power storage cells 20 forming the power storage device 100 may be one. Further, the power storage device 100 may include a binding member that applies a binding load to the cell stack 30 in the stacking direction. Alternatively, the power storage device 100 may include the electrode 10 configured to be a bipolar electrode.

### EXAMPLES

Specific examples of the above-described embodiment will now be described.

### Examples 1 and 2

### Manufacturing Positive Electrode Sheet

A positive electrode mixture was prepared containing LiFePO₄, carboxymethyl cellulose ammonium (NH₄-CMC), single-walled carbon nanotubes (SWCNT), and styrene-butadiene rubber (SBR) having the mixing ratio of the solid contents as shown in Table 1.

In the first step, the entirety of LifePO₄ and the entirety of NH₄-CMC are mixed to prepare a primary material. In the second step, the entirety of the SWCNT and water in the amount corresponding to 83 mass percent of the solid content ratio of a finally-prepared mixture are added to the primary material to prepare a secondary material. In the third step, the entirety of the SBR is added to the secondary material to prepare the mixture. In the third step, the mixture is agitated by a planetary mixer at 20 rpm for five hours to obtain a positive electrode mixture having a viscosity of ¼ or less of the initial viscosity of the secondary material.

A carbon-coated aluminum foil having a thickness of 30 μm was prepared as the positive current collector 21a. Through die coating, the positive electrode mixture is applied as a film to the surface of the positive current collector 21a on which the carbon coat layer C is formed. This forms a coat layer. The coat layer of the positive electrode mixture is heated at 50° C. to be dried and solidified. Then, the coat layer of the positive electrode mixture is compressed. The positive active material layer 21b having a thickness of 400 μm is formed on the positive current collector 21a. This manufactures Examples 1 and 2 of positive electrode sheets.

TABLE 1

| | | | Mixing Ratio (mass percent) | | | End | |
|---|---|---|---|---|---|---|---|
| | Active Material | CMC Salt | CMC | SWCNT | SBR | Ridge | Flow-Out |
| Example 1 | LiFePO₄ | NH₄ | 0.4 | 0.05 | 1.3 | ◯ | ◯ |
| Example 2 | LiFePO₄ | NH₄ | 0.6 | 0.05 | 1.3 | ◯ | ◯ |
| Comparative Example 1 | LiFePO₄ | NH₄ | 0.2 | 0.05 | 1.3 | — | ◯ |
| Comparative Example 2 | LiFePO₄ | Na | 0.6 | 0.05 | 1.3 | X | ◯ |

### Comparative Examples 1 and 2

As shown in Table 1, in Comparative Example 1, the mixing ratio of NH₄-CMC in the positive active material layer is 0.2 mass percent. In Comparative Example 2, a positive active material layer is formed from a positive electrode mixture that contains sodium carboxymethyl cellulose instead of carboxymethyl cellulose ammonium as CMC salt.

### Examples 3 to 5

### Manufacturing Negative Electrode Sheet

A negative electrode mixture was prepared containing graphite, carboxymethyl cellulose ammonium (NH₄-CMC), single-walled carbon nanotubes (SWCNT), and styrene-butadiene rubber (SBR) having the mixing ratios of the solid contents as shown in Table 2. In the first step, the entirety of graphite and the entirety of NH₄-CMC are mixed to prepare the primary material. In the second step, the entirety of the SWCNT and water in the amount corresponding to 60 mass percent of the solid content ratio of a finally-prepared mixture are added to the primary material to prepare a secondary material. In the third step, the entirety of SBR is added to the secondary material to prepare the mixture. In the third step, the mixture is agitated by a planetary mixer at 20 rpm for five hours to obtain a negative electrode mixture having a viscosity of ¼ or less of the initial viscosity of the secondary material.

A carbon-coated aluminum foil having a thickness of 10 μm was prepared as the negative current collector 22a. Through die coating, the negative electrode mixture is applied as a film to the surface of the negative current collector 22a on which the carbon coat layer C is formed. This forms a coat layer. The coat layer of the negative electrode mixture is heated at 50° C. to be dried and solidified. Then, the negative electrode mixture is compressed. The negative active material layer 22b having a thickness of 400 μm is formed on the negative current collector 22a. This manufactures Examples 3 to 5 of negative electrode sheets.

TABLE 2

| | | | Mixing Ratio (mass percent) | | | End | |
|---|---|---|---|---|---|---|---|
| | Active Material | CMC Salt | CMC | SWCNT | SBR | Ridge | Flow-Out |
| Example 3 | Graphite | NH₄ | 0.4 | 0.05 | 2.4 | ◯ | ◯ |
| Example 4 | Graphite | NH₄ | 0.4 | 0.01 | 2.4 | ◯ | ◯ |
| Example 5 | Graphite | NH₄ | 0.6 | 0.05 | 2.4 | ◯ | ◯ |
| Comparative Example 3 | Graphite | NH₄ | 0.2 | 0.05 | 2.4 | — | ◯ |
| Comparative Example 4 | Graphite | Na | 0.6 | 0.05 | 2.4 | X | ◯ |
| Comparative Example 5 | Graphite | NH₄ | 0.4 | 0 | 2.4 | ◯ | X |

### Comparative Examples 3 to 5

As shown in Table 2, in Comparative Example 3, the mixing ratio of NH₄-CMC in the negative active material layer is 0.2 mass percent. In Comparative Example 4, a negative active material layer is formed from a negative electrode mixture that contains sodium carboxymethyl cellulose instead of carboxymethyl cellulose ammonium as CMC salt. In Comparative Example 5, a negative active material layer is formed from a negative electrode mixture that does not contain SWCNT.

### Measurement of Edge Portion

In Examples 1 to 5 and Comparative Examples 1 to 5, the thickness ta and the dimension L of the edge portion 12b of the active material layer 12 are measured. Symbol [○] is used to indicate that the thickness ta of the edge portion 12b is less than or equal to 104% of the thickness t of the body 12a. Symbol [x] is used to indicate that the thickness ta of the edge portion 12b is greater than 104% of the thickness t of the body 12a. Symbol [○] is used to indicate that in a plan view of the active material layer 12, the dimension L from the boundary M to the boundary N is less than or equal to 5 mm. Symbol [x] is used to indicate that the dimension L is greater than 5 mm. The results are shown in Tables 1 and 2. In Tables 1 and 2, CMC salt is NH₄-CMC or Na-CMC, and CMC denotes NH₄-CMC.

In Comparative Examples 1 and 3, when the mixing ratio of NH₄-CMC was 0.2 mass percent, the edge portion 12b collapsed when compressed after the coat layer of each mixture was dried and solidified. This may be due to poor dispersion of the mixture. In Comparative Examples 1 and 3, since the edge portion 12b collapsed, the end ridge was not measured. As shown in Examples 1 and 2 and 3 to 5, when the mixing ratio of NH₄-CMC was 0.3 mass percent or greater and 0.6 mass percent or less, an end ridge was not formed.

As shown in Comparative Examples 2 and 4, when Na-CMC was used, the end ridge was formed. As shown in Examples 1 and 2 and 3 to 5, when NH₄-CMC was used, an end ridge was not formed.

The results show that when the mixture contains a specified amount of NH₄-CMC and is dried, solidified, and compressed to form the active material layer 12, an end ridge is not formed in the edge portion 12b, which differs from when the mixture contains Na-CMC.

When the mixture contains NH₄-CMC and is agitated, the thixotropic characteristic is lost. In this regard, SWCNT is contained in the mixture to avoid loss of the thixotropic characteristic. When a specified amount of SWCNT is contained, as shown in Examples 1 and 2 and 3 to 5, the edge portion 12b of the active material layer 12 did not spread out.

1. An electrode for a power storage device, the electrode comprising:
an active material layer arranged on a surface of a current collector; and
a non-coated portion arranged on the surface of the current collector other than where the active material layer is arranged, the non-coated portion surrounding the active material layer, wherein
the active material layer includes a body and an edge portion, the edge portion surrounding the body and being located between the body and the non-coated portion, and the body having a thickness of 100 μm or greater and 400 μm or less,
the active material layer contains an active material capable of storing and releasing a charge carrier, a carbon nanotube, and CMC derived from carboxymethyl cellulose ammonium (NH₄-CMC),
in the active material layer, a content amount of the CMC derived from carboxymethyl cellulose ammonium (NH₄-CMC) is 0.3 mass percent or greater and 0.6 mass percent or less,
in the active material layer, a content amount of the carbon nanotube is 0.005 mass percent or greater and 0.08 mass percent or less,
the edge portion has a thickness having a maximum value that is 104% of a thickness of the body, and
in a plan view of the electrode in a thickness-wise direction of the active material layer, the edge portion has a dimension from a boundary between the body and the edge portion to a distal end of the edge portion, the dimension having a maximum value of 5 mm.

2. The electrode according to claim 1, wherein
a carbon coat layer is arranged on the surface of the current collector, the carbon coat layer including a carbon particle and a binder, and
the active material layer is arranged on the carbon coat layer.

3. The electrode according to claim 1, wherein the carbon nanotube is a single-walled carbon nanotube.

4. A method for producing a mixture for an active material layer used to manufacture an electrode for a power storage device, the electrode including an active material layer arranged on a surface of a current collector, and a non-coated portion arranged on the surface of the current collector other than where the active material layer is arranged, the non-coated portion surrounding the active material layer, the active material layer including a body and an edge portion surrounding the body and located between the body and the non-coated portion, the method, comprising:
a first step of preparing a primary material by mixing a powder of an active material capable of storing and releasing a charge carrier with a powder of carboxymethyl cellulose ammonium (NH₄-CMC);
a second step of preparing a secondary material by mixing the primary material with a water-containing solvent and a carbon nanotube; and
a third step of preparing a mixture by mixing and agitating the secondary material with a water-based binder,
wherein a maximum value of a viscosity of the secondary material is referred to as an initial viscosity, and the mixture is agitated in the third step until the viscosity of the mixture becomes less than or equal to ⅓ of the initial viscosity.
